(19) United States
(12) Patent Application Publication
(10) Pub. No.: US 2026/0202292 A1
(43) Pub. Date: Jul. 16, 2026

(54) DEVICE AND METHOD FOR SETTING STRESS CORROSION CRACKING MONITORING INDICATING PARAMETERS USING AN ACOUSTIC EMISSION SENSOR

(71) Applicant: IUCF-HYU (INDUSTRY-UNIVERSITY COOPERATION FOUNDATION HANYANG UNIVERSITY), Seoul (KR)

(72) Inventors: Seung Hwan LEE, Seoul (KR); Jae Woong PARK, Goyang-si (KR); Jae Heon LEE, Seoul (KR)

(73) Assignee: IUCF-HYU (INDUSTRY-UNIVERSITY COOPERATION FOUNDATION HANYANG UNIVERSITY), Seoul (KR)

(21) Appl. No.: 19/132,663

(22) PCT Filed: Nov. 24, 2023
(86) PCT No.: PCT/KR2023/019144

§ 371 Date: Aug. 4, 2025

(30) Foreign Application Priority Data
Nov. 25, 2022 (KR) 10-2022-0160198

(51) Int. Cl. G01N 3/08

(52) U.S. Cl. CPC G01N 3/08; G01N 2203/0017; G01N 2203/0062; G01N 2203/024; G01N 2203/0658

(57) ABSTRACT

According to one aspect of the present invention, a device for setting a reference monitoring parameter for detecting stress corrosion cracking using an acoustic emission sensor includes: a database configured to store information on a first acoustic emission signal generated during a tensile test, a second acoustic emission signal generated under a first condition prior to the formation of stress corrosion cracking, and a third acoustic emission signal generated under a second condition during the formation of the stress corrosion cracking, a parameter derivation unit configured to derive a first monitoring parameter related to actual crack generation from the information on the first acoustic emission signal, and to derive a second monitoring parameter unrelated to stress corrosion cracking from the information on the second acoustic emission signal, and a monitoring parameter setting unit configured to set a third monitoring parameter, derived from the information on the third acoustic emission signal using the first and second monitoring parameters, as a reference parameter for detecting stress corrosion cracking.

### FIELD OF THE INVENTION

The present invention relates to the detection of stress corrosion cracking, and more particularly, to a device and method for setting reference monitoring parameters for detecting stress corrosion cracking using an acoustic emission sensor.

### BACKGROUND OF THE INVENTION

Piping or surrounding structures connected to piping used in equipment such as nuclear reactor heads or steam generators (SGs) in nuclear power plants, or in chemical plants, are susceptible to stress corrosion cracking (SCC) under high-temperature and high-pressure conditions.

Since such stress corrosion cracking poses a potential risk of accidents, various technologies have been developed to detect the initiation or propagation of stress corrosion cracking.

Among them, ultrasonic testing (UT), a type of nondestructive testing method, involves inspectors manually inspecting defects of structures using ultrasonic equipment after shutting down the power plant. This approach results in significant time and economic losses due to the plant shutdown, and the inspection results may vary depending on the individual capabilities of inspectors.

In addition, another nondestructive testing method, acoustic emission testing (AET), has its own challenges, such as difficulty in setting an appropriate threshold. Since all signals exceeding the threshold are collected in real time during AET, the amount of data becomes extremely large. Moreover, due to surrounding noise, it is very difficult to establish reliable detection criteria for identifying actual defects.

### SUMMARY OF THE INVENTION

### Problems to be Solved

The present invention has been devised to address the above-described problems, and it is an object of the invention to provide a device and method for setting reference monitoring parameters for detecting stress corrosion cracking using an acoustic emission sensor, which may contribute to improving the accuracy of stress corrosion cracking detection by setting monitoring parameters based on acoustic emission signals acquired from the acoustic emission sensor.

Another object of the present invention is to provide a device and method for setting reference monitoring parameters for detecting stress corrosion cracking using an acoustic emission sensor, which may reduce noise interference and the volume of data to be processed, as compared to conventional techniques, by setting monitoring parameters from acoustic emission signals acquired through the acoustic emission sensor.

### Technical Solution

According to one aspect of the present invention for achieving the above-described objects, a device for setting reference monitoring parameters for detecting stress corrosion cracking using an acoustic emission sensor comprises: a database configured to store information on a first acoustic emission signal generated during a tensile test, a second acoustic emission signal generated under a first condition prior to formation of stress corrosion cracking, and a third acoustic emission signal generated under a second condition during formation of the stress corrosion cracking, a parameter derivation unit configured to derive a first monitoring parameter related to actual crack generation from the information on the first acoustic emission signal, and to derive a second monitoring parameter unrelated to stress corrosion cracking from the information on the second acoustic emission signal, and a monitoring parameter setting unit configured to set a third monitoring parameter, derived from the information on the third acoustic emission signal using the first and second monitoring parameters, as a reference parameter for monitoring stress corrosion cracking.

According to another aspect of the present invention for achieving the above-described objects, a method for setting reference monitoring parameter for detecting stress corrosion cracking using an acoustic emission sensor comprises: deriving the characteristics of the first monitoring parameter related to actual crack generation from information on a first acoustic emission signal generated during a tensile test, deriving the characteristics of the second monitoring parameter unrelated to stress corrosion cracking from information on a second acoustic emission signal generated under a first condition prior to formation of the stress corrosion cracking, and setting a third monitoring parameter, obtained from information on a third acoustic emission signal generated under a second condition during formation of the stress corrosion cracking using the characteristics of the first and second monitoring parameters, as a characteristic of reference parameter for monitoring stress corrosion cracking.

### Advantages of the Invention

According to the present invention, by setting reference monitoring parameters for detecting stress corrosion cracking through tensile testing using an acoustic emission sensor and modeling of stress corrosion crack formation, stress corrosion cracking may be detected in real time based on the set reference parameters, thereby reducing both cost and time compared to conventional nondestructive inspection methods.

In addition, according to the present invention, by setting the reference monitoring parameters, noise included in the acoustic emission signals may be removed, thereby minimizing the volume of data to be processed.

### BRIEF DESCRIPTION OF THE DRAWINGS

FIG. 1 is a schematic diagram of a device for setting reference monitoring parameters for detecting stress corrosion cracking using an acoustic emission sensor according to an embodiment of the present invention.

FIG. 2 is a schematic diagram showing the configuration of a central processing unit illustrated in FIG. 1.

FIG. 3 is a diagram showing an actual example of a tensile test in which a first acoustic emission signal used in the reference monitoring parameter setting device according to the present invention is generated.

FIG. 4 and FIG. 5 are diagrams for explaining the first acoustic emission signal and the second acoustic emission signal used in the reference monitoring parameter setting device according to the present invention.

FIG. 6 is a diagram for explaining a process of deriving a third monitoring parameter in the reference monitoring parameter setting device according to the present invention.

FIG. 7 is a flowchart illustrating a method for setting reference monitoring parameters for detecting stress corrosion cracking using an acoustic emission sensor according to an embodiment of the present invention.

### DETAILED DESCRIPTION OF THE INVENTION

Throughout the present specification, like reference numerals refer to substantially identical components. In the following description, detailed explanations of components that are not directly related to the essential features of the present invention and of functions and structures that are already well known in the technical field of the invention may be omitted for clarity.

The meanings of the terms used in this specification shall be interpreted as follows.

The advantages and features of the present invention, and the manner in which they are achieved, will become apparent from the embodiments described below with reference to the accompanying drawings. However, the present invention is not limited to the embodiments disclosed herein, but may be implemented in various different forms. The embodiments are merely provided to fully disclose the invention and to enable those skilled in the art to clearly understand the scope of the invention, which shall be defined only by the scope of the appended claims.

The shapes, sizes, ratios, angles, and numbers disclosed in the drawings for describing the embodiments of the invention are merely illustrative, and the invention is not limited to the specific depictions shown. Identical reference numerals throughout the specification refer to identical components.

Furthermore, in describing the present invention, detailed explanations of known techniques may be omitted if such explanation is deemed to obscure the essential features of the invention.

Unless explicitly stated otherwise, terms such as “comprises,” “has,” and “includes” used in the specification do not exclude the possibility of adding other elements or features. A singular expression of a component shall be understood to include plural forms unless specifically stated otherwise.

In interpreting elements, unless otherwise explicitly stated, they shall be understood to include a margin of error.

Descriptions of time sequences using expressions such as “after,” “subsequent to,” “next,” and “before” may include both immediate and non-immediate sequences, unless terms like “immediately” or “directly” are explicitly used.

The expression “at least one” shall be understood to include all possible combinations of one or more associated items. For example, the phrase “at least one of a first item, a second item, and a third item” should be understood to mean: each of the first, second, and third items individually, as well as any combination of two or more of them.

The features of various embodiments of the present invention may be partially or entirely combined or integrated with one another. Various types of technical cooperation and linkage between such embodiments are also possible. The embodiments may be implemented independently or in conjunction with one another as needed.

Hereinafter, embodiments of the present invention will be described in detail with reference to the accompanying drawings.

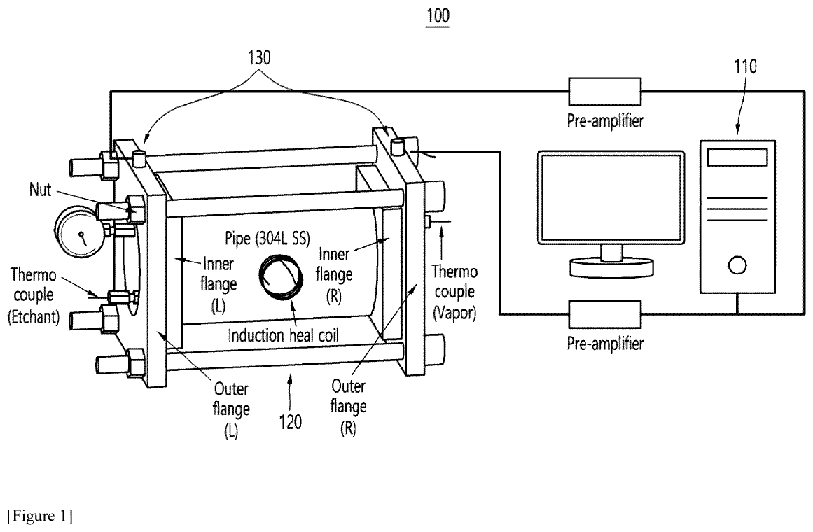

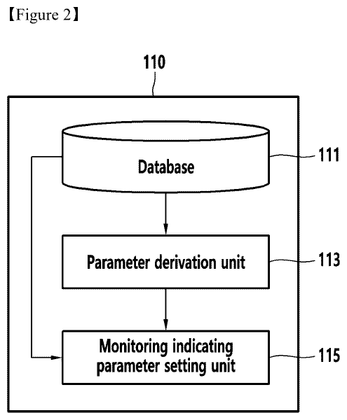

FIG. 1 is a schematic diagram of a device for setting reference monitoring parameters for detecting stress corrosion cracking using an acoustic emission sensor according to an embodiment of the present invention, and FIG. 2 is a schematic diagram illustrating the configuration of a central processing unit shown in FIG. 1.

As shown in FIGS. 1 and 2, a device for setting reference monitoring parameters for detecting stress corrosion cracking using an acoustic emission sensor (hereinafter referred to as the “monitoring parameter setting device”) according to the present invention includes a central processing unit 110, a stress corrosion cracking modeling unit 120, and an acoustic emission sensor 130.

The central processing unit 110 is configured to set a reference monitoring parameter for detecting stress corrosion cracking (SCC), and includes a database 111, a parameter characteristic derivation unit 113, and a detecting reference parameter setting unit 115.

The database 111 is configured to store information on a first acoustic emission (AE) signal generated during a tensile test, a second acoustic emission signal generated under a first condition prior to the formation of stress corrosion cracking, and a third acoustic emission signal generated under a second condition during the formation of stress corrosion cracking. In other words, the first acoustic emission signal refers to information on an acoustic emission signal generated during actual crack formation, the second acoustic emission signal refers to information on an acoustic emission signal generated under a condition where stress corrosion cracking has not occurred, and the third acoustic emission signal may refer to information on all acoustic emission signals, including noise, generated during the process in which stress corrosion cracking is formed.

In one embodiment, the first acoustic emission signal is received from an acoustic emission sensor used in a tensile test conducted on a sample of the structure to be monitored, and the database 111 may store information on the first acoustic emission signal for each sample of the structure to be monitored.

In the following embodiment, the structure to be monitored is assumed to be a pipe used in a nuclear power plant, and the pipe is assumed to be formed of 304 L stainless steel.

For example, the first acoustic emission signal may be sensed by the acoustic emission sensor during a tensile test conducted on 304 L stainless steel, which is the material of the pipe to be monitored. The purpose of using the first acoustic emission signal generated during the tensile test, which corresponds to the acoustic emission signal generated during actual crack formation, is to enable the extraction of monitoring parameters corresponding to actual stress corrosion cracking from the third acoustic emission signal, which will be described below.

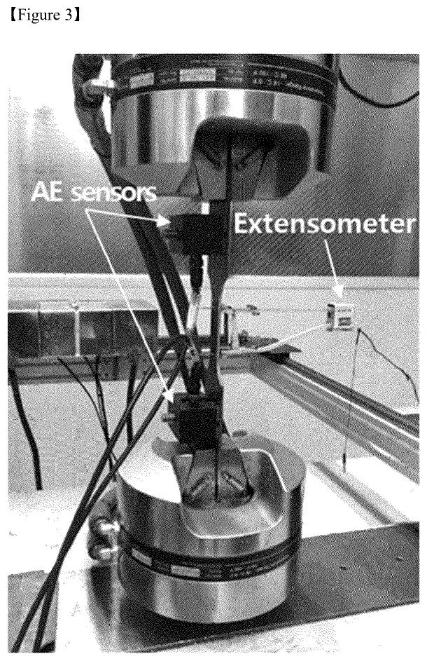

FIG. 3 is a diagram illustrating an actual example of a tensile test in which a first acoustic emission signal used in the detecting reference parameter setting device according to the present invention is generated.

As shown in FIG. 3, it may be seen that a pair of acoustic emission (AE) sensors is used during the tensile test of 304 L stainless steel, and the first acoustic emission signal may be sensed through the AE sensors.

The parameter characteristic derivation unit 113 is configured to derive a first monitoring parameter related to actual crack generation from the information on the first acoustic emission signal, and to derive a second monitoring parameter unrelated to stress corrosion cracking from the information on the second acoustic emission signal.

For example, the parameter characteristic derivation unit 113 may derive amplitude, energy, frequency characteristic, and waveform information as the first or second monitoring parameter from the first or second acoustic emission signal.

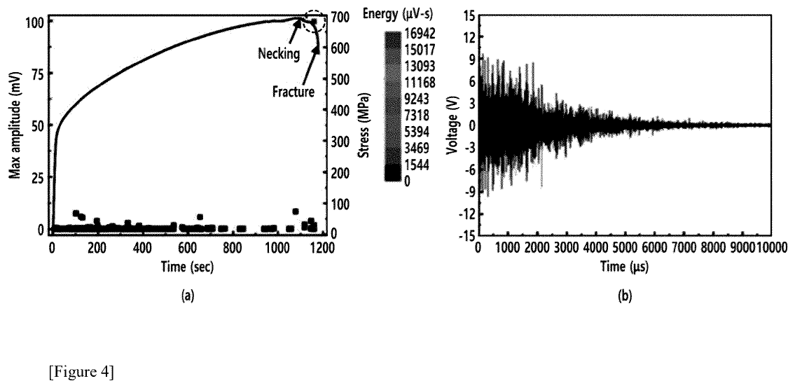

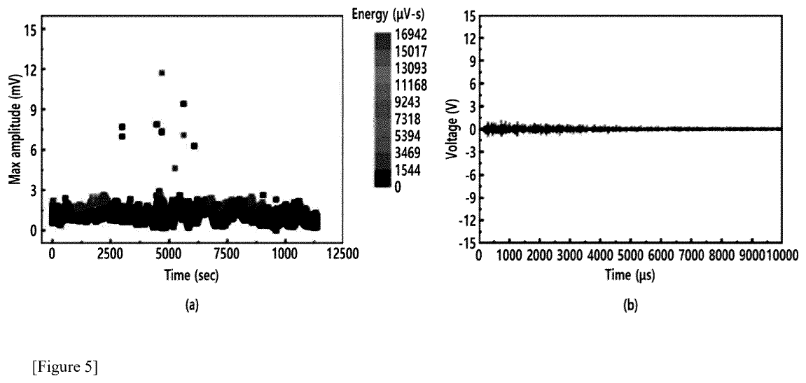

FIGS. 4 and 5 are diagrams for explaining the first acoustic emission signal and the second acoustic emission signal used in the monitoring parameter setting device according to the present invention.

The first acoustic emission signal is an acoustic emission signal generated during actual crack formation. As shown in FIG. 4(a), the amplitude of the signal is approximately 99 mV, and the energy is approximately 17,000 uV .s. In addition, the signal exhibits high intensity uniformly in the frequency band of 60 to 180 kHz, and the waveform is identified as a burst type, as illustrated in FIG. 4(b). Therefore, the parameter derivation unit 113 may derive these characteristics as the first monitoring parameter.

In addition, the second acoustic emission signal is a signal generated under a condition in which stress corrosion cracking has not occurred (i.e., a control test in which corrosion conditions are removed). As shown in FIG. 5(a), the amplitude and energy of the signal are significantly low, at or below 12 mV and 3777 μV·s, respectively.

Furthermore, the dominant frequency bands of the signal appear at 62.5~64.5 kHz, 127~129 kHz, and 190~192 kHz with very weak intensity within narrow frequency ranges, and the waveform is identified as a continuous type, as illustrated in FIG. 5(b). Therefore, the parameter derivation unit 113 may derive these characteristics as the second monitoring parameter.

Through this, it may be understood that if the waveform of the acoustic emission signal is a continuous type, it corresponds to the second acoustic emission signal, which is unrelated to stress corrosion cracking. On the other hand, if the waveform is a burst type, it corresponds to the first acoustic emission signal generated during actual crack formation. The first and second acoustic emission signals may be distinguished based on the amplitude and energy values.

The monitoring parameter setting unit 115 sets a third monitoring parameter, derived from the information on the third acoustic emission signal using the first and second monitoring parameters, as a reference parameter for monitoring stress corrosion cracking.

In other words, the first monitoring parameter is derived from the first acoustic emission signal generated during actual crack formation in the tensile test, and the second monitoring parameter is derived from the second acoustic emission signal generated under a first condition corresponding to a control test in which stress corrosion constituents are removed. The third monitoring parameter is then set as the reference for detecting stress corrosion cracking by comparing and contrasting these parameters with the information on the third acoustic emission signal generated under the second condition during the formation of stress corrosion cracking.

Here, the third acoustic emission signal corresponds to raw data comprising various acoustic emission signals, including noise, generated under the second condition that models a general stress corrosion cracking scenario.

In one embodiment, the waveform information of the second monitoring parameter, derived from the second acoustic emission signal generated under the first condition prior to the occurrence of stress corrosion cracking, corresponds to a continuous type, whereas the waveform information of the third monitoring parameter, which is set as the reference monitoring parameter, corresponds to a burst type that is the same as the waveform information of the first monitoring parameter.

This is because the second acoustic emission signal generated under the first condition, which corresponds to the control experiment where stress corrosion cracking has not yet occurred, exhibits a continuous waveform pattern, whereas the third monitoring parameter, set as the reference, has a waveform pattern identical to the burst-type waveform of the first acoustic emission signal generated during actual crack formation in the tensile test.

In another embodiment, the frequency characteristic information of the third monitoring parameter, set as the reference, may correspond to a frequency band identical to that of the first monitoring parameter.

This is because the major frequency band of the first acoustic emission signal generated during actual crack formation in the tensile test is the same as the major frequency band of the third monitoring parameter set as the reference parameter.

In another embodiment, the amplitude information of the third monitoring parameter, which is set as the reference, may correspond to an amplitude value greater than or equal to the upper limit of the amplitude values of the second monitoring parameter.

This is because the amplitude values of the second acoustic emission signal, which are generated under the first condition corresponding to the control experiment where stress corrosion cracking has not yet occurred, remain below the upper limit. Accordingly, by setting the amplitude of the third monitoring parameter to be equal to or greater than this upper limit, acoustic emission signals unrelated to stress corrosion cracking may be excluded.

Therefore, the monitoring parameter setting unit 115 may first remove acoustic emission signals corresponding to the second monitoring parameter from the third acoustic emission signal, and then derive the third monitoring parameter by referring to the first monitoring parameter, thereby setting it as the reference monitoring parameter for detecting stress corrosion cracking.

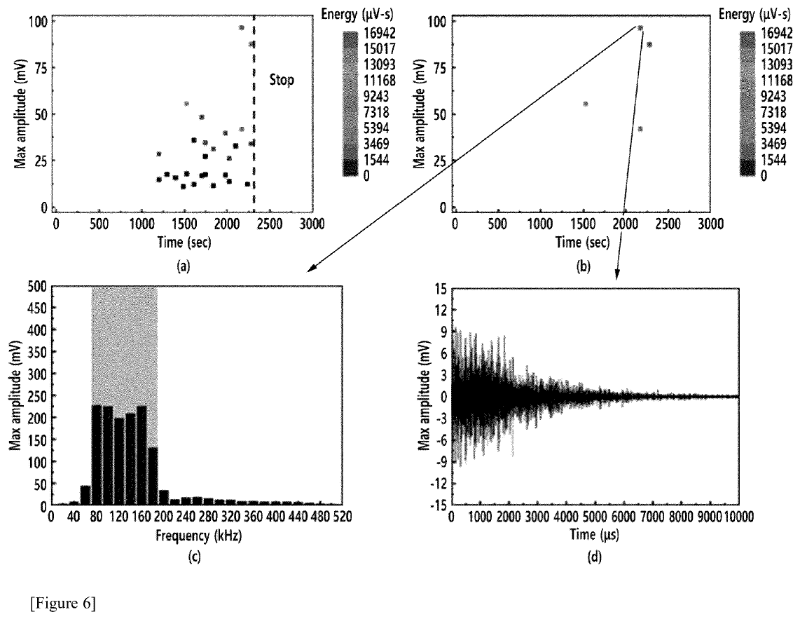

FIG. 6 is a diagram for explaining a process of deriving the third monitoring parameter in the monitoring parameter setting device according to the present invention.

For example, the monitoring parameter setting device according to the present invention may, as illustrated in FIG. 6(a), remove, as a first step, acoustic emission signals corresponding to the waveform information of the second monitoring parameter—i.e., signals of continuous waveform type with amplitude and energy values equal to or less than 12 mV and 3777 μV·s, respectively—as shown in FIG. 6(b).

Subsequently, the monitoring parameter setting device may derive the characteristics of acoustic emission signals that correspond to the waveform information of the first monitoring parameter—i.e., signals of burst waveform type within the primary frequency band of 60~180 kHz—as the third monitoring parameter, and set it as the reference parameter for detecting stress corrosion cracking.

As shown in FIG. 6(c), the frequency band of the signal derived as the third monitoring parameter is identified to be in the range of 60~180 kHz, and as shown in FIG. 6(d), the waveform of the derived signal corresponds to a burst type.

In this manner, the monitoring parameter setting device according to the present invention extracts the necessary parameter from the acoustic emission signal acquired via the acoustic emission sensor by referencing information obtained from the control experiment, and sets the extracted parameter as the reference monitoring parameter for detecting stress corrosion cracking. As a result, it is possible to significantly improve detection accuracy and greatly reduce the volume of data to be processed.

In addition, the monitoring parameter setting device according to the present invention sets the determined reference monitoring parameter for detecting stress corrosion cracking as a detection threshold. When the value detected during the stress corrosion cracking process modeled by the stress corrosion cracking modeling unit 120 exceeds the set threshold, it is possible to verify the reliability of the reference monitoring parameter by inspecting the interior of the pipe in the stress corrosion cracking modeling unit and confirming whether stress corrosion cracking has occurred.

Furthermore, the reference monitoring parameter set by the monitoring parameter setting device according to the present invention may be applied as a detection threshold for acoustic emission sensors installed in actual operating pipelines of a nuclear power plant, thereby enabling real-time and more accurate detection of stress corrosion cracking without requiring a plant shutdown.

The stress corrosion cracking modeling unit 120 is configured to generate stress corrosion cracking in a test object identical to the structure to be monitored, and the acoustic emission sensor 130 is installed on the stress corrosion cracking modeling unit 120.

For example, when the structure to be monitored is a 304 L stainless steel pipe, the stress corrosion cracking modeling unit may include inner and outer flanges on both ends of a 304 L stainless steel pipe, and may include an induction heater for heating a liquid injected into the pipe. The inner and outer flanges are mechanically fastened using bolts.

In one embodiment, distilled water may be injected under a first condition, which corresponds to a control experiment in which corrosion components are removed, before stress corrosion cracking is formed. A corrosive solution may be injected under a second condition during the process of forming stress corrosion cracking.

At this time, the acoustic emission sensor 130 may be configured to sense the second acoustic emission signal generated from the stress corrosion cracking modeling unit 120 under the first condition, and to sense the third acoustic emission signal generated from the stress corrosion cracking modeling unit 120 under the second condition.

In addition, the acoustic emission sensor may be composed of two R15i sensors and may further include two preamplifiers. The sensor may have a resonant frequency of 75 kHz and an operating frequency range of 50 to 400 kHz.

Meanwhile, by utilizing the stress corrosion cracking modeling unit, the monitoring parameter setting device according to the present invention is capable of stably acquiring acoustic emission signals even in high-temperature environments.

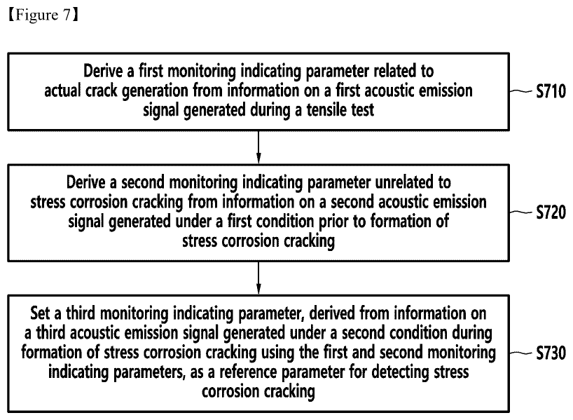

Hereinafter, a method for setting a reference monitoring parameter for detecting stress corrosion cracking will be described with reference to FIG. 7.

FIG. 7 is a flowchart illustrating a method for setting a reference monitoring parameter for detecting stress corrosion cracking using an acoustic emission sensor, according to an embodiment of the present invention.

First, the monitoring parameter setting device according to the present invention derives a first monitoring parameter related to actual crack generation from information on a first acoustic emission signal generated during a tensile test (S710).

Next, the monitoring parameter setting device derives a second monitoring parameter unrelated to stress corrosion cracking from information on a second acoustic emission signal generated under a first condition prior to formation of stress corrosion cracking (S720).

Next, the monitoring parameter setting device sets a third monitoring parameter, derived from the information on a third acoustic emission signal generated under a second condition during the formation of stress corrosion cracking, using the first and second monitoring parameters, as a reference parameter for detecting stress corrosion cracking (S730).

In one embodiment, the first, second, and third monitoring parameters may include amplitude, energy, frequency characteristic, and waveform information of the first, second, and third acoustic emission signals, respectively.

In another embodiment, the waveform information of the second monitoring parameter may correspond to a continuous type, while the waveform information of the third monitoring parameter may correspond to a burst type, which is the same as the waveform information of the first monitoring parameter.

It will be understood by those skilled in the art that the foregoing embodiments may be implemented in other specific forms without departing from the technical spirit or essential features of the present invention.

Therefore, the embodiments described above should be considered illustrative in all aspects and not restrictive. The scope of the present invention is defined by the appended claims rather than the foregoing detailed description, and all variations and modifications derived from the meanings and scopes of the claims and their equivalents are to be construed as being included within the scope of the present invention.

1. A device for setting monitoring parameters for detecting stress corrosion cracking using an acoustic emission sensor, the device comprising:
a database configured to store information on a first acoustic emission signal generated during a tensile test, a second acoustic emission signal generated under a first condition prior to formation of stress corrosion cracking, and a third acoustic emission signal generated under a second condition during formation of the stress corrosion cracking;
a parameter derivation unit configured to derive a first monitoring parameter related to actual crack generation from the information on the first acoustic emission signal, and to derive a second monitoring parameter unrelated to stress corrosion cracking from the information on the second acoustic emission signal; and
a monitoring parameter setting unit configured to set a third monitoring parameter, derived from the information on the third acoustic emission signal using the first and second monitoring parameters, as a reference parameter for monitoring stress corrosion cracking.

2. The device of claim 1,
wherein the first acoustic emission signal is received from an acoustic emission sensor used in the tensile test on a sample of a structure to be monitored,
and the database stores the information on the first acoustic emission signal for each of the samples of the structure to be monitored.

3. The device of claim 1, further comprising:
a stress corrosion cracking modeling unit configured to generate stress corrosion cracking in a test object identical to the structure to be monitored; and
an acoustic emission sensor installed on the stress corrosion cracking modeling unit and configured to sense the second and third acoustic emission signals.

4. The device of claim 3,
wherein the stress corrosion cracking modeling unit injects distilled water under the first condition to generate the second acoustic emission signal,
and injects a corrosive solution under the second condition to generate the third acoustic emission signal.

5. The device of claim 1,
wherein each of the first, second, and third monitoring parameters include amplitude, energy, frequency characteristic, and waveform information of the corresponding acoustic emission signal.

6. The device of claim 5,
wherein waveform information of the second monitoring parameter corresponds to a continuous type,
and waveform information of the third monitoring parameter corresponds to a burst type, which is the same as waveform information of the first monitoring parameter.

7. The device of claim 5,
wherein frequency characteristic information of the third monitoring parameter corresponds to a frequency band identical to that of the first monitoring parameter.

8. The device of claim 5,
wherein amplitude information of the third monitoring parameter corresponds to an amplitude greater than or equal to an upper limit of the amplitude values of the second monitoring parameter.

9. A method for setting monitoring parameters for detecting stress corrosion cracking using an acoustic emission sensor, the method comprising:
deriving a first monitoring parameter related to actual crack generation from information on a first acoustic emission signal generated during a tensile test;
deriving a second monitoring parameter unrelated to stress corrosion cracking from information on a second acoustic emission signal generated under a first condition prior to formation of the stress corrosion cracking; and
setting a third monitoring parameter, derived from information on a third acoustic emission signal generated under a second condition during formation of the stress corrosion cracking using the first and second monitoring parameters, as a reference parameter for monitoring stress corrosion cracking.

10. The method of claim 9,
wherein each of the first, second, and third monitoring parameters include amplitude, energy, frequency characteristic, and waveform information of the corresponding acoustic emission signal.

11. The method of claim 10,
wherein waveform information of the second monitoring parameter corresponds to a continuous type,
and waveform information of the third monitoring parameter corresponds to a burst type, which is the same as waveform information of the first monitoring parameter.
